(19) United States
(12) Patent Application Publication
(10) Pub. No.: US 2012/0321020 A1
(43) Pub. Date: Dec. 20, 2012

(54) COMPLENTARY DIFFERENTIAL INPUT BASED MIXER CIRCUIT

(75) Inventors: MUNIR ELDESOUKI, Ontario (CA); Mohamed Jamal Deen, Ontario (CA)

(73) Assignee: King Abdulaziz City Science and Technology, Riyadh (SA)

(21) Appl. No.: 13/159,439

(22) Filed: Jun. 14, 2011

(51) Int. Cl. H04L 25/06; G06G 7/18

(52) U.S. Cl. 375/318; 327/335

(57) ABSTRACT

A method, an apparatus and/or a system of complementary differential input based mixer circuit is disclosed. In one aspect, the method includes inputting a single ended signal to a mixer circuit comprising a differential input circuit through a complementary differential transistor pair of the differential input circuit of the mixer circuit. The method also includes converting the signal ended signal to a differential signal through the complementary differential transistor pair of the differential input circuit to drive the mixer circuit.

### FIELD OF TECHNOLOGY

The embodiments of the present technology pertain to analog circuits in general and pertain particularly to complementary differential input based mixer circuit.

### BACKGROUND

A signal receiver/transmitter (e.g., RF receiver/transmitter) may convert a single ended signal to a differential signal to drive a circuit of the signal receiver that operates based on the differential signal. The single ended signal may be converted to the differential signal through an on-chip transformer, a balun (balance/unbalance) or multiple circuits (e.g., multiple analog to digital converters in a transmitter). However, on-chip transformers may be large in size and may occupy a large chip area. Also the on-chip transformers may have a low quality factor and/or may be expensive. Further, using multiple circuits of the same kind may increase a chip area occupied as well. The on-chip transformer based signal receiver may be of a large size due to the large chip area occupied by the on-chip transformers. This may limit designing a smaller size receiver. Further the on-chip transformer based signal receiver may have poor performance and/or may be expensive.

### SUMMARY

A method, an apparatus and/or a system of complementary differential input based mixer circuit is disclosed.

In one aspect, a method includes inputting a single ended signal to a mixer circuit comprising a differential input circuit through a complementary differential transistor pair of the differential input circuit of the mixer circuit. The method also includes converting the signal ended signal to a differential signal through the complementary differential transistor pair of the differential input circuit to drive the mixer circuit.

In another aspect, a method of a signal receiver includes coupling a single ended output circuit of an amplifier circuit of the signal receiver to a differential input circuit of a mixer circuit of the signal receiver through a complementary differential transistor pair of the differential input circuit of the mixer circuit to input a single ended signal from the single ended output circuit of the amplifier circuit to the mixer circuit. The method further includes converting a single ended signal from the single ended output circuit of the amplifier circuit to a differential signal pair through the complementary differential transistor pair of the differential input circuit of the mixer circuit to drive the mixer circuit based on the single ended signal.

In yet another aspect, a mixer circuit includes a differential input circuit of the mixer circuit to input a single ended signal. The differential input circuit includes a complementary differential transistor pair of a differential input circuit of the mixer circuit to convert the single ended signal to a differential signal pair to drive the mixer circuit.

In another aspect, the system includes a receiver circuit to at receive a signal. The system also includes a mixer circuit of the receiver circuit to modify a frequency of the signal. The mixer circuit includes a complementary differential transistor pair of a differential input circuit of the mixer circuit to convert the single ended signal inputted to the mixer circuit to a differential signal pair through the complementary differential transistor pair of the differential input circuit.

### BRIEF DESCRIPTION OF THE FIGURES

Example embodiments are illustrated by way of example and not limitation in the figures of the accompanying drawings, in which like references indicate similar elements and in which:

FIG. 1 is a block diagram of a mixer circuit, according to one or more embodiments.

FIG. 2 is a schematic view of the mixer circuit of FIG. 1, according to one or more embodiments.

FIG. 3 is a schematic view of the mixer circuit of FIG. 2 illustrating an operation of the complementary differential transistor pair, according to one or more embodiments.

FIG. 4 is a schematic view of the mixer circuit of FIG. 2 illustrating an operation of the cross coupled multiplier circuit during a positive cycle of the local oscillator input, according to one or more embodiments.

FIG. 5 is a schematic view of the mixer circuit of FIG. 2 illustrating an operation of the cross coupled multiplier circuit during a negative cycle of the local oscillator input, according to one or more embodiments.

FIG. 6 is a system view of the example embodiment of the mixer circuit in an example signal receiver system, according to one or more embodiments.

FIG. 7 is a layout view of the receiver circuit of FIG. 6, according to one or more embodiments.

FIG. 8 is a table view illustrating the comparison of the performances of the receiver system including mixer circuit with complementary differential transistor pair with other receiver systems, according to one or more embodiments.

FIG. 9 is process flow diagram illustrating the operation of the mixer circuit, according to one or more embodiments.

FIG. 10 is a process flow diagram illustrating the operation of the complementary differential transistor pair, according to one or more embodiments.

Other features of the present embodiments will be apparent from the accompanying drawings and from the detailed description that follows.

### DETAILED DESCRIPTION

A method, apparatus and system of complementary differential input based mixer circuit is disclosed. Although the present embodiments have been described with reference to specific example embodiments, it will be evident that various modifications and changes may be made to these embodiments without departing from the broader spirit and scope of the various embodiments.

In one or more embodiments, a mixer circuit may be configured to convert a frequency of a signal to a different frequency based on a desired operation of the signal. In some embodiments, the signal may be up-converted. In certain embodiments, the signal may be down-converted. For example, in a receiver circuit, the mixer may down convert a signal received through an antenna to a frequency compatible for signal processing. For example in a transmitter circuit, the mixer circuit may up-convert a signal to a frequency at which the signal is desired to be transmitted. The mixer circuit may be a part of a radio frequency (RF) system. The mixer circuit may convert the frequency of a signal through multiplying the signals inputted to the mixer circuit. In one or more embodiments, when one signal is multiplied with another signal through a mixer circuit, the output of the mixer circuit may be the sum and difference of the frequencies of the signals that are multiplied. For example, if a signal of 2 MHz and another signal of 3 MHz are multiplied, then new signal at frequencies 5 MHz and 1 MHz are generated as output signal. In some embodiments, the output may also include signals of spurious frequencies. The signals of spurious frequencies may be removed through a filter circuit. The signal multiplication may be represented through an example equation 1 shown below:

$${V}_{1} = {A}_{1} cos {ω}_{1} t \\ {V}_{2} = {A}_{2} cos {ω}_{2} t \\ \begin{matrix}{V}_{0} = {V}_{1} \cdot {V}_{2} \\ = {A}_{1} cos {ω}_{1} t \cdot {A}_{2} cos {ω}_{2} t \\ = \frac{{A}_{1} {A}_{2}}{2} [ cos ( {ω}_{1} - {ω}_{2} ) t + cos ( {ω}_{1} + {ω}_{2} ) t ]\end{matrix} \qquad ( 1 )$$

One of the input signals of the mixer circuit may be generated through a local oscillator circuit. The other input signal may be an RF signal received from an antenna in some embodiments. In other embodiments, the RF signal may be received from another circuit coupled to the mixer circuit. In one or more embodiments, the local oscillator circuit may be an electronic circuit configured to generate a signal for the purpose of converting a signal of interest to a different frequency using a mixer circuit.

The mixer circuit may be a double balanced mixer circuit. In one or more embodiments, the double balanced mixer circuit may be a Gilbert cell double balanced mixer circuit. A double balanced mixer circuit may suppress the input signal to the mixer circuit from appearing in the output signal. The Gilbert cell architecture may make the implementation of the mixer circuit on an integrated circuit feasible. The Gilbert cell mixer may be configured to operate as an analog mixer or a switching mixer. In one or more embodiment, when used in the switching mode the Gilbert cell mixer has a switching signal fed to the mixer circuit through the local oscillator circuit. This may multiply the RF signal inputted through an RF circuit of the mixer circuit by either +1 or −1. Multiplying the RF input signal by +1 may transfer the RF input level to the output port with no change. Multiplying it by −1 may invert the output (i.e. a 180° phase change).

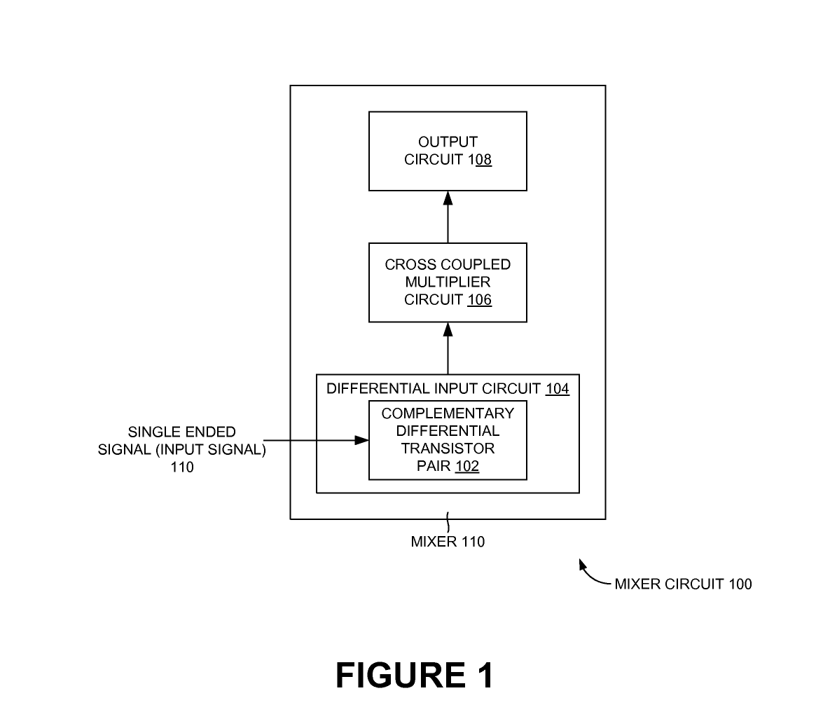

FIG. 1 is a block diagram of a mixer circuit, according to one or more embodiments. In particular, FIG. 1 illustrates a mixer circuit 100, a differential input circuit 104, a complementary differential transistor pair 102, a single ended signal 110, a cross coupled multiplier circuit 106 and an output circuit 108.

In one or more embodiments, the mixer circuit 100 may be a differential mixer circuit. The differential mixer circuit may be a Gilbert cell double balanced mixer circuit. In an example embodiment, the mixer circuit 100 may be a part of a RF signal receiver that receives a communication signal. In the example embodiment thereof, the mixer circuit 100 may convert a received signal to a signal of intermediate frequency to make the received signal compatible for further processing. In another example embodiment, the mixer circuit 100 may be a part of a RF transmitter. In yet another example embodiment, the mixer circuit 100 may be used as an RF multiplier where the input signals to the mixer circuit are multiplied in frequency. In the example embodiment thereof, the output of the mixer circuit may be a signal having the sum and/or difference of the frequencies of the input signals to the mixer circuit 100.

In one of more embodiments, the mixer circuit 100 may include at least a differential input circuit 104, a cross coupled multiplier circuit 106 and/or an output circuit 108 as illustrated in FIG. 1. The different circuits may be coupled to each other. In one or more embodiments, the differential input circuit may include a complementary differential transistor pair 102.

The differential input circuit 104 may be configured to receive an input signal. The input signal may be a single ended signal 110. The single ended signal 110 may be inputted to the mixer circuit 100 through the complementary differential transistor pair 102 of the differential input circuit 104. The complementary differential input pair 102 may convert a single ended signal to a differential signal through the complementary differential transistor pair 102 to drive the mixer circuit 100. The mixer circuit 100 may be configured to operate based on a differential signal to drive the mixer circuit 100. However, the input signal received from the other circuits coupled to the mixer circuit 100 may be single ended signals. The single ended signal may have to be translated or converted to a differential signal to drive the mixer circuit.

In one or more embodiments, the complementary differential transistor pair 102 may convert the single ended signal to a corresponding differential signal. The complementary differential transistor pair 102 may generate a differential current in each of a branch of the mixer circuit associated with each of a transistor forming the complementary differential transistor pair 102. In one or more embodiments, each transistor forming the complementary differential transistor pair 102 may generate opposite current in each of the branch of the mixer circuit 100 associated with each of the transistors forming the complementary differential transistor pair 102. In one or more embodiments, the opposite current or the differential current generated through the complementary differential transistor pair may form the differential signal from the single ended signal which enables the single ended signal to drive the differential mixer.

In one or more embodiments, the complementary differential transistor pair 102 may be coupled to the cross coupled multiplier circuit 106 such that the differential signal from the complementary differential transistor pair 102 of the differential input circuit 104 may be fed to the cross coupled multiplier circuit 106 as one of the inputs of the cross coupled multiplier circuit 106. The cross coupled multiplier circuit 106 may have at least two inputs. One of the inputs may be the differential signal from the complementary differential transistor pair 102 of the differential input circuit 104. In one of more embodiments, the other input may be a signal generated through a local oscillator coupled to the mixer circuit 100 through the cross coupled multiplier circuit 106 (not shown in FIG. 1). In one or more embodiments, the differential signal may be an RF signal.

In one or more embodiments, the cross coupled multiplier circuit 106 may convert the frequency of the single ended signal converted to the differential signal to a different frequency. The frequency of the differential signal may be converted through multiplying the differential signal with signal generated through the local oscillator. For example, the differential signal may have a frequency f1 and the signal generated through the local oscillator may have frequency f2. The signal of frequency f1 may be multiplied with signal of frequency f2 to generate an output signal of frequency (f1+f2) and (f1−f2). In some embodiments of the example the output may also include harmonics of the input signals which may be filtered out.

The cross coupled multiplier circuit 106 may include a number of cross coupled transistors. The cross coupled multiplier circuit 106 may be configured to form the multiplication function to multiply the differential signal current from the complementary differential transistor pair 102 with the signal generated through the local oscillator applied across the number of cross coupled transistor forming the cross coupled multiplier circuit 106. The cross coupled multiplier circuit 106 may provide a switching function. The cross coupled multiplier circuit 106 may multiply the differential signal from the complementary differential transistor pair 102 with the signal from the local oscillator inputted to the cross coupled multiplier circuit 106 through the switching operation. In the frequency domain the switching operation may leads to the usual sum and difference frequencies of the input signals, but may also include further terms e.g. +−3*f_{LO}, +−5*f_{LO}, etc. The advantage of a switching mixer is that it can achieve a lower noise figure (NF) and larger conversion gain. This may be because the transistors providing the switching operation may act either like a low resistor (switch closed) or large resistor (switch open) and in both cases only minimum noise is added. From the circuit perspective many mixers circuits may be configured to multiply through switching operation, just by increasing the local oscillator amplitude.

In one or more embodiments, the cross coupled multiplier circuit 106 may be coupled to the output circuit 108 of the mixer circuit 100. In one or more embodiments, the signal resulting from multiplying the input signals applied to the cross coupled multiplier circuit (referred to as multiplied signal hereafter) may be fed to the output circuit 108. The output circuit 108 may include an output load (not shown in FIG. 1). The multiplied signal may be further multiplied to the load impedance to generate an output signal. The output circuit 108 may deliver the output signal to another circuit coupled to the mixer circuit that is configured to receive the output signal from the mixer circuit.

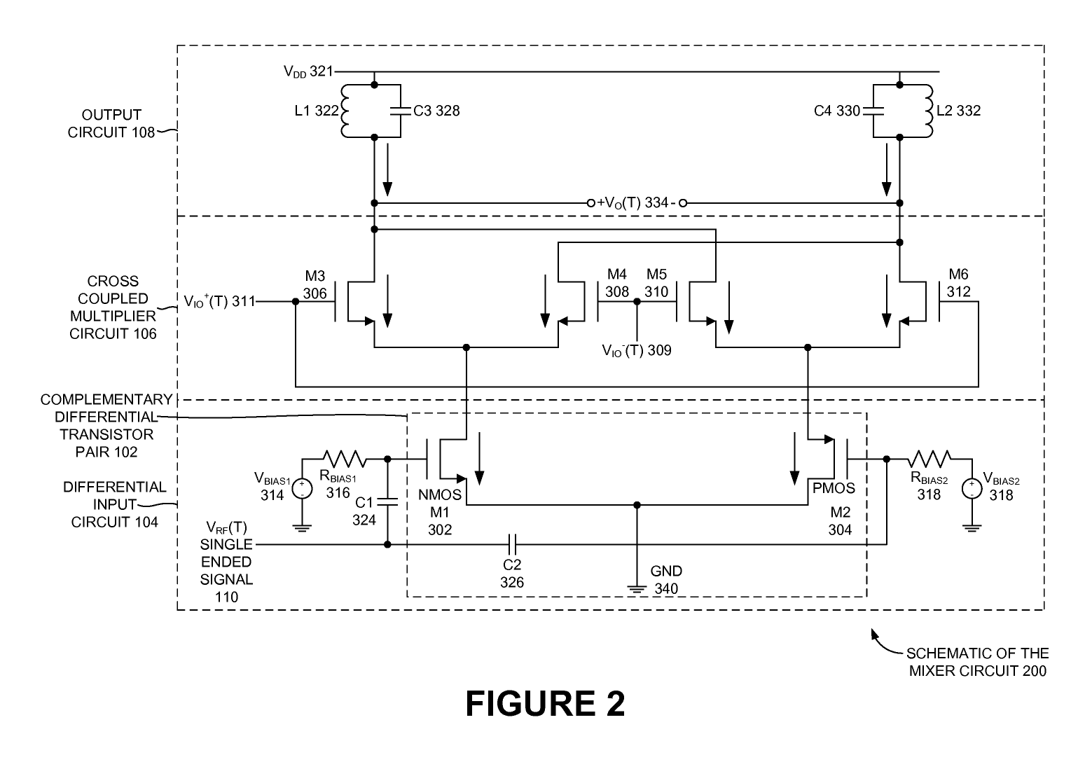

FIG. 2 is a schematic view of the mixer circuit of FIG. 1, according to one or more embodiments. In particular FIG. 2 illustrates the schematic view of the differential input circuit 104 of the mixer circuit 100, the schematic view of the complementary differential transistor pair 102 of the differential input circuit 104, the schematic view of the cross coupled multiplier circuit 106 of the mixer circuit 100, the schematic view of the output circuit 108 of the mixer circuit 100, the transistors M1-M6 302, 304, 306, 308, 310 and 312, the capacitors C1-C4 324, 326, 328 and 330, the inductors L1 322 and L2 332, the bias voltages Vbias1 314 and Vbias2 318, the resistors Rbias1 316 and Rbias2 320, the single ended signal 110, supply voltage Vdd 321, the negative cycle of local oscillator signal Vlo⁻ 309, the positive cycle of local oscillator signal Vlo⁺ 311, the output voltage Vo 334 and the ground 340.

In one or more embodiments, the mixer circuit 100 comprises a differential input circuit 104 coupled to the cross coupled multiplier circuit 106 which is further coupled to the output circuit 108. The differential input circuit 104 includes the complementary differential transistor pair 102. The complementary differential transistor pair 102 may include a PMOS transistor M1 302 and a NMOS transistor M2 304 configured to form the complementary differential transistor pair 102. The drain of the transistor M1 302 and the source of transistor M2 304 may be coupled to the cross coupled multiplier circuit 106. The single ended signal Vrf 301 may be inputted to the complementary differential transistor pair 102 through the gate of transistor M1 302 and gate of transistor M2 304 via a capacitor C1 324 and capacitor C2 326 respectively as illustrated in FIG. 2. The gates of the transistor M1 302 and transistor M2 304 may be coupled together to receive the single ended signal as input through the capacitors C1 324 and C2 326 respectively. The source of transistor M1 302 and the drain of the transistor M2 304 may be coupled to a ground 340. The transistor M1 302 may be biased through a bias circuit associated with transistor M1 302. The bias circuit associated with transistor M1 302 may include a bias voltage source Vbias1 314 coupled to the gate of the transistor M1 302 through the resistor Rbias1 316 as illustrated in FIG. 2. The transistor M2 304 may be biased through a bias circuit associated with transistor M2 304. The bias circuit associated with transistor M2 304 may include a bias voltage source Vbias2 318 coupled to the gate of the transistor M2 304 through the resistor Rbias2 320 as illustrated in FIG. 2.

In one or more embodiments, the differential input circuit 104 may receive the single ended signal 110 through the complementary differential input pair 102. In one or more embodiments, the complementary differential transistor pair 102 may generate two differential signals in the mixer circuit from a single ended signal 110 input. In one or more embodiments, the complementary differential transistor pair 102 may generate a differential current in the circuit branches associated with the NMOS transistor M1 302 and PMOS transistor M2 304 respectively from the single ended signal 110 input. The current of the NMOS transistor in saturation region is given by the example equation 2 as follows:

$${I}_{D} = \frac{1}{2} {μ}_{n} {C}_{ox} \frac{w}{L} {( {V}_{GS} - {V}_{t} )}^{2} \qquad ( 2 )$$

The current of a PMOS transistor in saturation region is given by the example equation 3 as follows

$${I}_{D} = \frac{1}{2} {μ}_{p} {C}_{ox} \frac{w}{L} {( {V}_{GS} - {V}_{t} )}^{2} \qquad ( 3 )$$

In one or more embodiments, upon increasing V_{GS}, (V_{GS}−Vₜ)² may increase. This in turn may increase the current I_{D} based on example equation 2 and example equation 3. In one or more embodiments, when V_{GS} decreases, (V_{GS}−Vₜ)² may decrease in response. In one or more embodiments, I_{D} may decrease in response to decreasing (V_{GS}−Vₜ)². The above mentioned pattern work for both the NMOS and PMOS transistors. However, when V_{rf} 310, the voltage of the single ended signal 110 increases, the voltage V_{GS} of NMOS transistor M1 302 may increase and the voltage V_{GS} of PMOS transistor M2 304 may decrease, causing I_{D} of NMOS transistor M1 302 to increase while I_{D} of PMOS may decrease and vice versa. The overall V-I conversion may be summarized as follows:
when the single ended signal input is increasing, the current in the NMOS transistor M1 302 branch may increase while the current in the PMOS transistor M2 304 branch may decrease, and
when the single ended signal input is decreasing, the current in the NMOS transistor M1 302 branch may decrease while the current in the PMOS transistor M2 304 branch may increase.

These two opposite currents mentioned above may create a differential signal pair and thus converts the single ended signal to a differential signal.

The transconductance of PMOS transistor M2 304 may be one third the transconductance of the NMOS transistor M1 302. The current in the PMOS branch (circuit branch associated with the PMOS transistor M2 304) may not be accurately matched to the current in the NMOS branch (circuit branch associated with the NMOS transistor M1 302) based on the difference in sizes of the transistors and the difference in transconductance of the transistors. In one or more embodiments, the current in the branch associated with the NMOS transistor M1 302 of the complementary differential transistor pair may be substantially matched to the current in the branch associated with the PMOS transistor M2 304 of the complementary differential transistor pair to increase an efficiency of the mixer circuit 100.

In one or more embodiments, the cross coupled multiplier circuit 106 may include two pairs of cross coupled transistors M3-M6 306, 308, 310 and 312. The sources of transistors M3 312 and M4 310 may be coupled to the drain of the NMOS transistor M1 302 of the complementary differential transistor pair 102. The sources of transistor M5 308 and M6 306 may be coupled to the drain of the PMOS transistor M2 304 of the complementary differential pair 102. The gates of transistor M3 312 and transistor M6 306 may be coupled together to receive the positive cycle of local oscillator voltage Vlo⁺ 311. The gates of transistor M4 310 and M5 308 are coupled together to receive negative cycle of the local oscillator voltage Vlo⁻ 309. The drains of transistor M3 312 and M4 310 may be coupled to the first terminal of the LC tank comprising L1 322 and C3 328. The drains of transistor M5 308 and M6 306 are coupled to the first terminal of the LC tank comprising L2 332 and C4 330. The second terminals of the LC tanks may be coupled to the supply voltage V_{DD} 321. The cross coupled multiplier circuit 106 may multiply the differential signal from the complementary differential transistor pair with the local oscillator signal to generate a signal with a shifted frequency (e.g., intermediate frequency). In one or more embodiments, the transistors M3-M6 forming the cross coupled multiplier circuit 106 may be of the same kind. For example, in one embodiment the transistor M3-M6 may be NMOS transistors. In another embodiment, the transistor M3-M6 may be PMOS transistors.

In one or more embodiments, the output circuit 108 may comprise the LC tanks and the output terminal that may output the output voltage Vo 334. The inductor L1 322 may be coupled to the capacitor C3 328 to form one of the LC tanks and the inductor L2 332 and capacitor C4 330 may be coupled to form the other LC tank. The LC tanks may be an output load and the impedance of the LC tanks may be multiplied to the signal resulting from multiplying the input signals of the cross coupled multiplier circuit 106 to generate the output voltage Vo 334. The supply voltage V_{DD} 321 may provide the voltage to operate the mixer circuit 100.

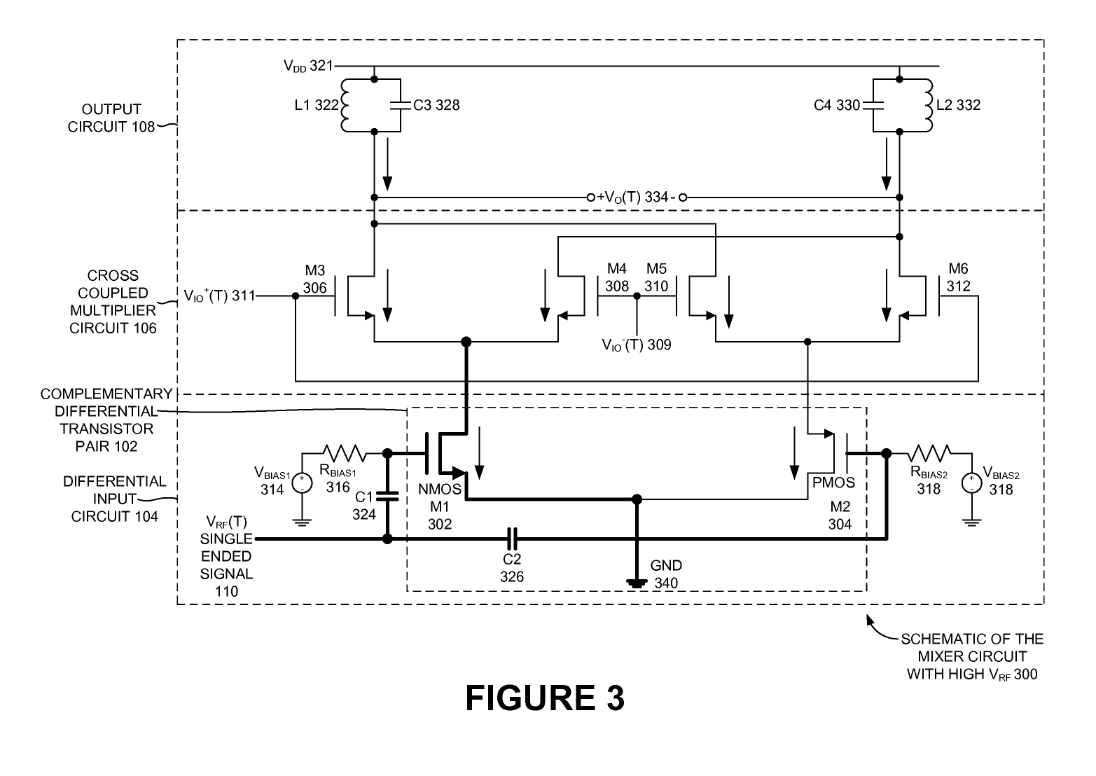

FIG. 3 is a schematic view of the mixer circuit of FIG. 2 illustrating an operation of the complementary differential transistor pair, according to one or more embodiments. In particular, FIG. 3 illustrates the schematic view of the differential input circuit 104 of the mixer circuit 100, the schematic view of the complementary differential transistor pair 102 of the differential input circuit 104, the schematic view of the cross coupled multiplier circuit 106 of the mixer circuit 100, the schematic view of the output circuit 108 of the mixer circuit 100, the transistors M1-M6 302, 304, 306, 308, 310 and 312, the capacitors C1-C4 324, 326, 328 and 330, the inductors L1 322 and L2 332, the bias voltages Vbias1 314 and Vbias2 318, the resistors Rbias1 316 and Rbias2 320, voltage Vrf 301 associated with the single ended signal 110, supply voltage Vdd 321, the negative cycle of local oscillator signal Vlo⁻ 309, the positive cycle of local oscillator signal Vlo⁺ 311, the output voltage Vo 334 and the ground 340.

In one or more embodiments, a single ended signal 110 may be inputted to a mixer circuit 100 through the complementary differential transistor pair 102 of the differential input circuit 104 of the mixer circuit 100. In one or more embodiments, the complementary differential input pair 102 may convert the signal ended signal 110 to a differential signal to drive the mixer circuit 100. In one or more embodiments, the mixer circuit may be configured to operate based on a differential signal. In one or more embodiments, increasing a voltage of the single ended signal 110 inputted through the complementary differential transistor pair 102 of the differential input circuit 104 may increase the current in the branch associated with the PMOS transistor while the current in the branch associated with the NMOS transistor may decrease. In one or more embodiments, decreasing the voltage of the single ended signal 110 inputted to the complementary differential transistor pair 102 of the differential input circuit 104 may decrease the current in the branch associated with the PMOS transistor while the current in the branch associated with the NMOS transistor may increase.

Based on this, the complementary differential transistor pair 102 may generate a differential current in each of a branch of the mixer circuit 110 associated with each of the transistors (NMOS transistor M1 302 and PMOS transistor M2 304) forming the complementary differential transistor pair 102 of the differential input circuit 104 of the mixer circuit 100. The single ended signal 110 may be converted to a differential signal pair compatible with the mixer circuit 100 through generating the differential current via the complementary differential transistor pair 102. In one or more embodiments, the differential current may form a differential signal pair. In one or more embodiments, converting the single ended signal 110 to a differential signal pair may enable the single ended signal to drive the mixer circuit through the complementary differential transistor pair 102.

In one or more embodiments, in a positive cycle of the single ended signal 110 the NMOS transistor M1 302 may be switched on whereas the PMOS transistor M2 304 may be switched off. In one or more embodiments, in a negative cycle of the single ended signal 110 the PMOS transistor M2 304 may be switched on and the NMOS transistor M1 306 may be switched off (not shown in FIG. 3). Voltage Vrf 310 of the single ended signal 110 may be converted to current Irf through the complementary differential transistor pair where Irf may be proportional to the Vrf 310. The current in the branch associated with the NMOS transistor 302 of the complementary differential transistor pair 102 may be matched substantially to the current in the branch associated with the PMOS transistor 304 of the complementary differential transistor pair to increase an efficiency of the mixer circuit 100. The differential signal generated from the single ended signal 110 through the complementary differential transistor pair 102 may be delivered to the cross coupled multiplier circuit 106 coupled to the complementary differential transistor pair 102. In one or more embodiments, the single ended signal 110 may be an RF signal.

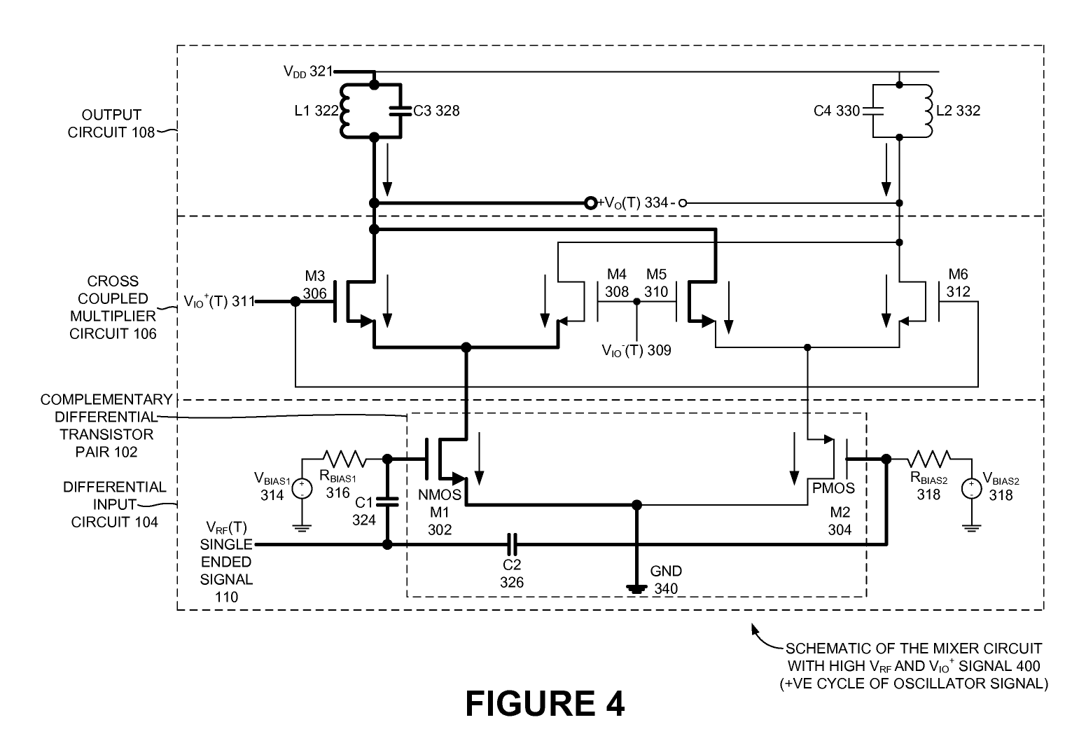

FIG. 4 is a schematic view of the mixer circuit of FIG. 2 illustrating an operation of the cross coupled multiplier circuit during a positive cycle of the local oscillator input, according to one or more embodiments. In particular FIG. 4 illustrates the schematic view of the differential input circuit 104 of the mixer circuit 100, the schematic view of the complementary differential transistor pair 102 of the differential input circuit 104, the schematic view of the cross coupled multiplier circuit 106 of the mixer circuit 100, the schematic view of the output circuit 108 of the mixer circuit 100, the transistors M1-M6 302, 304, 306, 308, 310 and 312, the capacitors C1-C4 324, 326, 328 and 330, the inductors L1 322 and L2 332, the bias voltages Vbias1 314 and Vbias2 318, the resistors Rbias1 316 and Rbias2 320, voltage Vrf 301 associated with the single ended signal 110, supply voltage Vdd 321, the negative cycle of local oscillator signal Vlo⁻ 309, the positive cycle of local oscillator signal Vlo⁺ 311, the output voltage Vo 334 and the ground 340.

In one or more embodiments, the signal generated through a local oscillator circuit may inputted to the cross coupled multiplier circuit 106 through the gates of transistors M3-M6 306, 308, 310 and 312 that form the cross coupled multiplier circuit. In one or more embodiments, the positive cycle of the local oscillator signal may be inputted to transistors M3 306 and M6 312. The gates of the transistors M3 306 and M6 312 may be coupled together to receive the local oscillator voltage VIo⁺ 311. In one or more embodiments, the negative cycle of the local oscillator signal may be inputted to transistors M4 308 and M5 310. The gates of the transistors M4 308 and M5 310 may be coupled together to receive the local oscillator voltage VIo− 309.

In the embodiment of FIG. 4, during the positive cycle of the single ended signal 110, the NMOS transistor M1 302 of the complementary differential transistor pair 102 may be switched on and the PMOS transistor M2 304 of the complementary differential transistor pair 102 may be switched off. The complementary differential transistor pair 102 may convert the single ended signal to a differential current. The differential current from transistor M1 302 may be fed to the transistor M3 306 and M4 308 of the cross coupled multiplier circuit 106. In one or more embodiments, during the positive cycle of local oscillator circuit transistor M3 306 may be switched on. In one or more embodiments, Vlo+ 311 may be high during the positive cycle of the local oscillator signal. In one or more embodiments, the local oscillator signal inputted through the gate of transistor M3 306 and the differential signal inputted through the source of transistor M3 306 may be multiplied when transistor M3 306 is switched on. The multiplied signal may be further multiplied with the impedance of the LC tank formed through coupling inductor L1 322 and capacitor C3 328 to generate the output signal Vo 334.

In one or more embodiments, in a negative cycle of the single ended signal 110 (not shown in FIG. 4), transistor M2 304 may be switched on and the differential current may be generated through the complementary differential transistor pair 102. The differential signal may be inputted to transistors M5 310 and M8 312. The positive cycle of the local oscillator signal may switch on the transistor M6 312. The differential signal generated from the negative cycle of the single ended signal 110 through transistor M2 304 may be multiplied with the local oscillator signal through switching on the transistor M6 312. The multiplied signal may further be multiplied with the impedance of the LC tank formed through coupling inductor L2 332 and C4 330 to generate the output signal Vo 334.

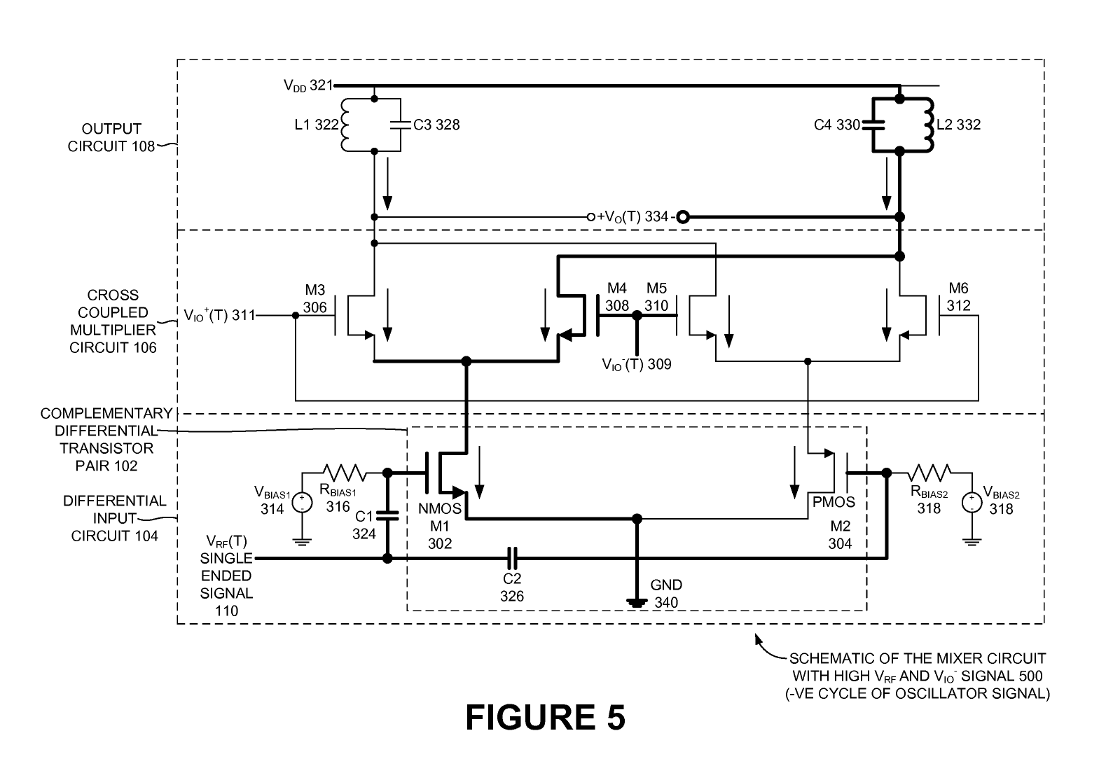

FIG. 5 is a schematic view of the mixer circuit of FIG. 2 illustrating an operation of the cross coupled multiplier circuit during a negative cycle of the local oscillator input, according to one or more embodiments. As described in FIG. 4 in the embodiment of FIG. 5, during the positive cycle of the single ended signal 110, the NMOS transistor M1 302 of the complementary differential transistor pair 102 may be switched on and the PMOS transistor M2 304 of the complementary differential transistor pair 102 may be switched off. The complementary differential transistor pair 102 may convert the single ended signal to a differential current. The differential current from transistor M1 302 may be fed to the transistor M3 306 and M4 308 of the cross coupled multiplier circuit 106. In one or more embodiments, during the negative cycle of local oscillator circuit transistor M4 308 may be switched on. In one or more embodiments, Vlo⁻ 309 may be high during the negative cycle of the local oscillator signal. In one or more embodiments, the local oscillator signal inputted through the gate of transistor M4 308 and the differential signal inputted through the source of transistor M4 308 may be multiplied when transistor M4 308 is switched on. The multiplied signal may be further multiplied with the impedance of the LC tank formed through coupling inductor L2 332 and capacitor C4 330 to generate the output signal Vo 334. Similarly in the negative cycle of the single ended signal 110 the PMOS transistor 304 may be switched on and the differential current may be multiplied with local oscillator signal through switching on transistor M5 310. The multiplied signal may further be multiplied with the impedance of the LC tank including inductor L1 322 and capacitor C3 328 to generate the output signal Vo 334.

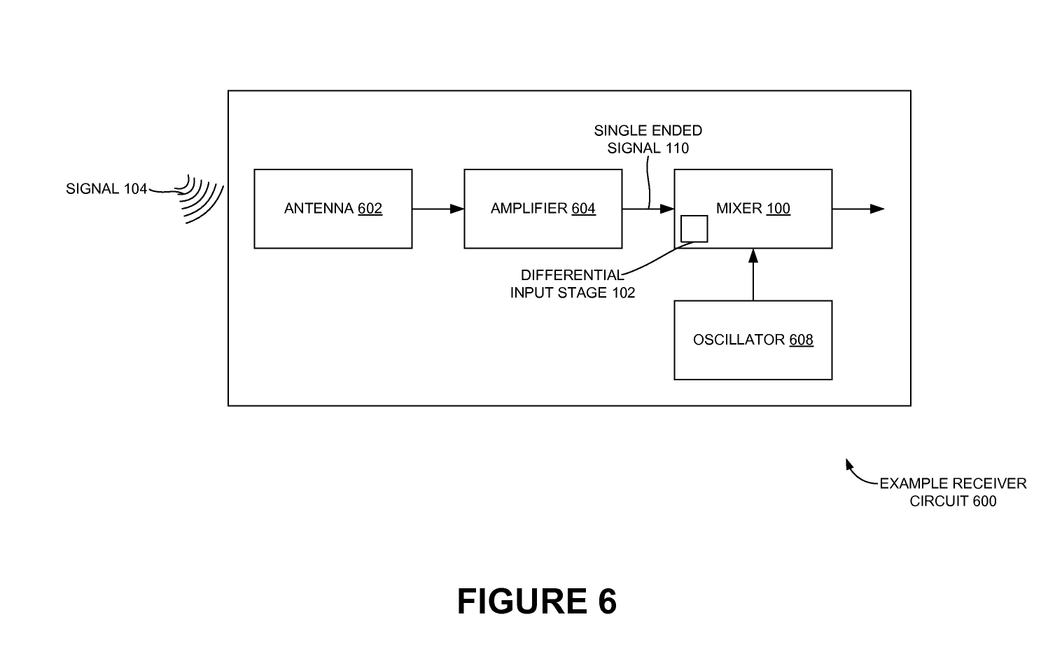

FIG. 6 is a system view of the example embodiment of the mixer circuit in an example signal receiver system, according to one or more embodiments. In particular, FIG. 6 illustrates a mixer circuit 100, a complementary differential transistor pair 102, an antenna 602, an amplifier circuit 604, a single ended output circuit 606 of the amplifier circuit 604, a local oscillator circuit 608. In one or more embodiments, the signal receiver system may be an RF receiver. The receiver may be a wireless signal receiver. In some embodiments, the receiver may be a narrow band receiver.

In one or more embodiments, the antenna 602 may receive a signal transmitted through a transmitter. The signal received through the antenna 602 may be delivered to an amplifier circuit 604. The amplifier circuit may be low noise amplifier (LNA). In one or more embodiments, the signal received through the antenna 602 may be amplified through the amplifier circuit 604. The amplifier circuit may output a single ended signal 110 through a single ended output circuit 606 of the amplifier circuit 604. The single ended output circuit 606 of the amplifier circuit 604 may be coupled to mixer circuit 100 through the complementary differential transistor pair 102 of the differential input circuit 104 (not shown in FIG. 6) of the mixer circuit 100 to receive the single ended signal from the amplifier circuit 604.

In one or more embodiments, the complementary differential transistor pair 102 converts the single ended signal 110 to a differential signal to drive the mixer circuit 100. In one or more embodiments, a differential current in each of a branch of the mixer circuit associated with each of the transistors forming the complementary differential transistor pair 102 may be generated through the complementary differential transistor pair 102 of the differential input circuit 104 of the mixer circuit 100. In one or more embodiments, the single ended signal 110 from the single ended output circuit 606 of the amplifier circuit 604 may be converted to a differential signal pair compatible with the mixer circuit 100 through generating the differential current via the complementary differential transistor pair 102, the differential current to form a differential signal pair. The single ended signal of the single ended output circuit 606 of the signal receiver 600 to drive the mixer circuit 100 of the signal receiver through converting the single ended signal to a differential signal pair via the complementary differential transistor pair 102. In one or more embodiments, the differential current to form a differential signal pair.

In one or more embodiments, the differential signal pair may be multiplied with a signal generated through the local oscillator circuit 608. In one or more embodiments, multiplied as used in this application may refer to RF multiplication where the frequencies of the signals being multiplied may be added or subtracted. The term multiplication is well known in the art of RF mixing. The multiplied signal may be outputted through an output circuit 108 (not shown in FIG. 6) of the mixer circuit 100.

In another embodiment, the mixer circuit 100 may be a part of a transmitter system. In the example embodiment of a transmitter system, the mixer circuit 100 a processor may generate a signal to be transmitted. The signal generated through the processor may be a single ended signal. The signal may be inputted to the complementary differential transistor pair 102 of the mixer circuit 100 through an analog to digital converter. In yet another embodiment, the mixer circuit 100 may be a part of a transceiver.

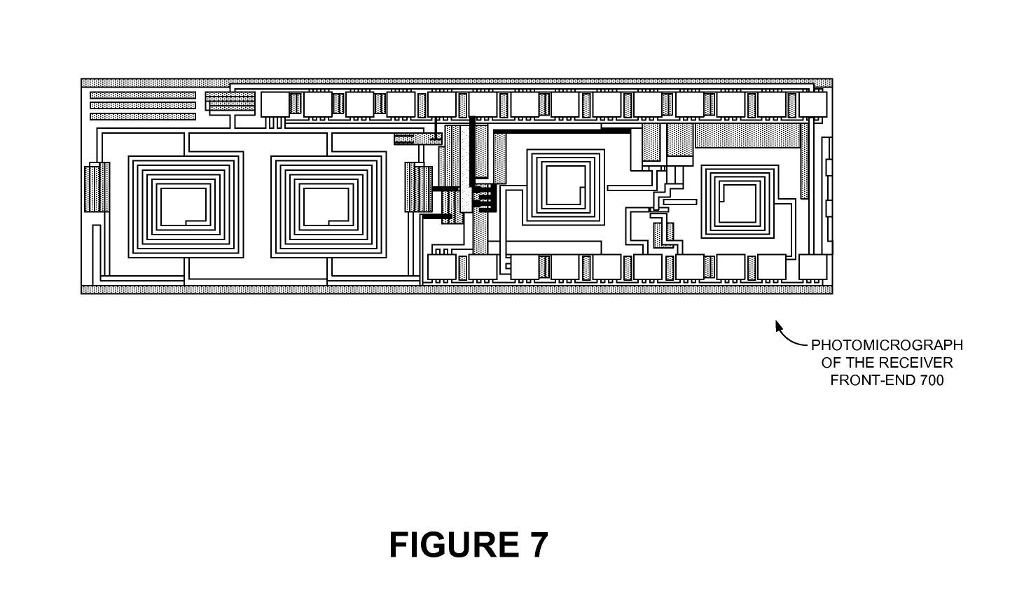

FIG. 7 is a layout view of the receiver circuit of FIG. 6, according to one or more embodiments. The receiver may be fabricated in TSMC 0.18-μm CMOS technology as shown in FIG. 7. The amplifier circuit may be a narrow-band low-noise amplifier circuit. The narrow-band low-noise amplifier circuit may be implemented using an inductively source degenerated cascade structure and the mixer circuit may be implemented according to double balanced configuration with complementary PMOS and NMOS transistors for the single ended signal (path). The total designed chip area may be at most 2.7×0.77=2.08 mm². In one or more embodiments, the total designed chip area may be small due to the differential input circuit mixer circuit that converts the single ended signal to a differential signal through the complementary differential transistor pair of the differential input circuit.

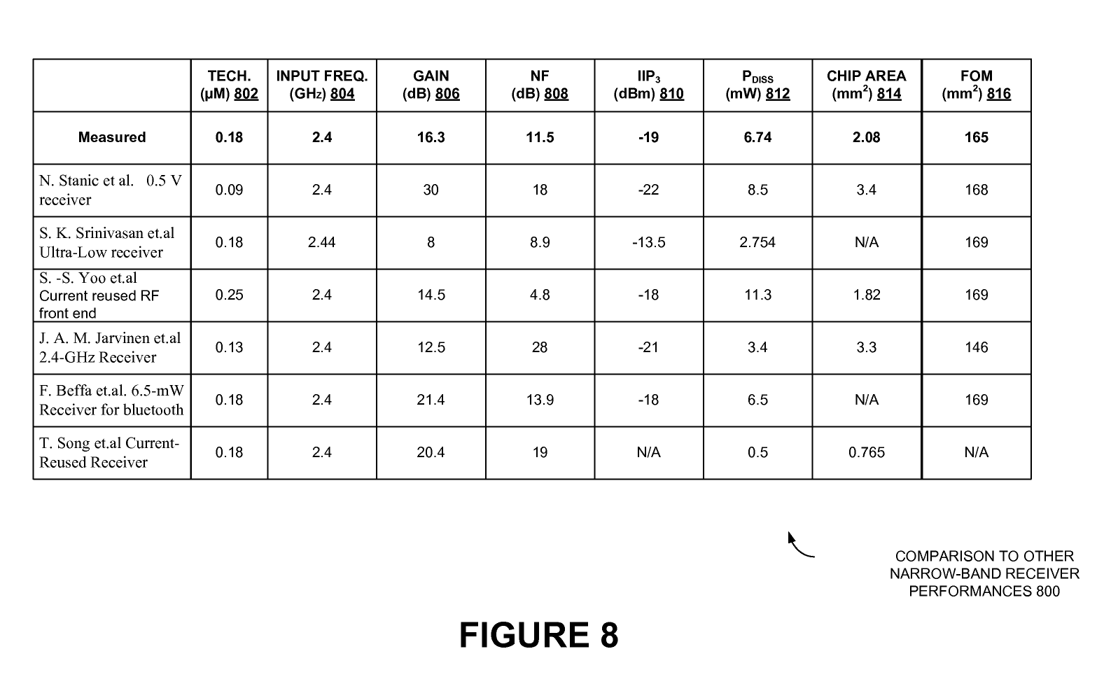

FIG. 8 is a table view illustrating the comparison of the performances of the receiver system including mixer circuit with complementary differential transistor pair with other receiver systems, according to one or more embodiments. In particular, FIG. 8 illustrates the CMOS technology column 802, an input frequency column 804, a gain (dB) 806, a noise figure (NF) column 808, a 3^{rd} order input referred intercept point (IIP₃) column 810, a dissipation power column 812, a chip area column 814 and a Figure of Merit (FOM) column 816.

In one or more embodiments, figure of merit (FoM) 816, and it is defined through example equation 4:

FOM=20 log(f_{RF})+G+IIP³−NF−10 log(P_{diss}) (4)

where all values are measured in normalized units. The term f_{RF} is the input frequency of the RF signal in Hz normalized to 1 Hz, G is the gain of the receiver 806 in dB normalized to 1 dB, IIP³ is the linearity in dBm normalized to 1 dBm, NF is the noise figure in dB normalized to 1 dB, and P_{diss} the power consumption of the receiver in mW normalized to 1 mW. In one or more embodiments, the receiver system including mixer circuit with complementary differential transistor pair achieves 16.3 dB gain and 6.74 mW power consumption while using 2.08 mm² chip area. The row indicating “measured” correspond to the measured value associated with the differential input receiver with complementary transistor pair input of the disclosure. It is compared with other receivers with mixer circuits in the related space.

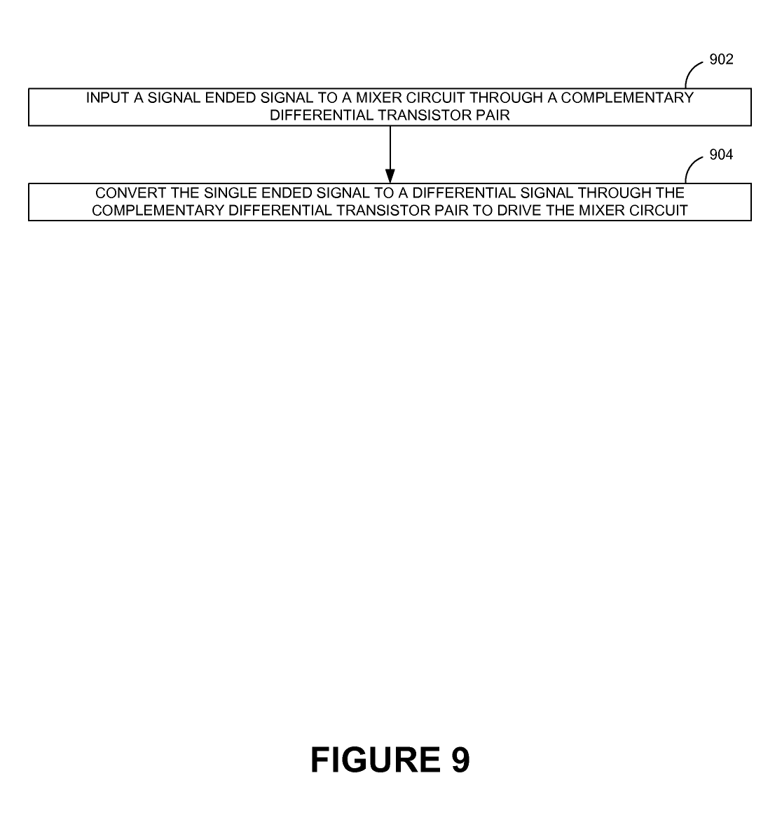

FIG. 9 is process flow diagram illustrating the operation of the mixer circuit, according to one or more embodiments. In operation 902, a single ended signal 110 may be inputted to a mixer circuit 100 through a complementary differential transistor pair 102. The complementary differential transistor pair 102 may be included in the differential input circuit 104 of the mixer circuit 100. In one or more embodiments, the single ended signal 110 inputted to the mixer circuit 100 may be converted to a differential signal pair through the complementary differential input pair 102 to drive the mixer circuit 100 in operation 904. In one or more embodiments, a differential current may be generated in each of a branch of the mixer circuit 100 associated with each of the transistors forming the complementary differential transistor pair 102 through the complementary differential transistor pair 102 of the differential input circuit of the mixer circuit 100. In one or more embodiments, the single ended signal may be converted to a differential signal pair compatible with the mixer circuit through generating the differential current via the complementary differential transistor pair, the differential current to form a differential signal pair. The single ended signal 110 may drive the mixer circuit through converting the single ended signal to a differential signal pair via the complementary differential transistor pair 102.

In one or more embodiments, the complementary differential transistor pair 102 may include a PMOS transistor M2 304 coupled to an NMOS transistor M1 302 to form the complementary differential transistor pair 102. In one or more embodiments, increasing a voltage Vrf 301 of the single ended signal 110 applied to the complementary differential transistor pair 102 of the differential input circuit to increase the current in the branch associated with the PMOS transistor M2 304 while the current in the branch associated with the NMOS transistor M1 302 is decreased simultaneously. Decreasing the voltage Vrf 301 of the single ended signal 110 applied to the complementary differential transistor pair 102 of the differential input circuit to decrease the current in the branch associated with the PMOS transistor M2 304 while the current in the branch associated with the NMOS transistor M1 302 is increased simultaneously. In one or more embodiments, the current in the branch associated with the NMOS transistor 302 of the complementary differential transistor pair 102 may be substantially matched to the current in the branch associated with the PMOS transistor 304 of the complementary differential transistor pair 102 to increase an efficiency of the mixer circuit 100.

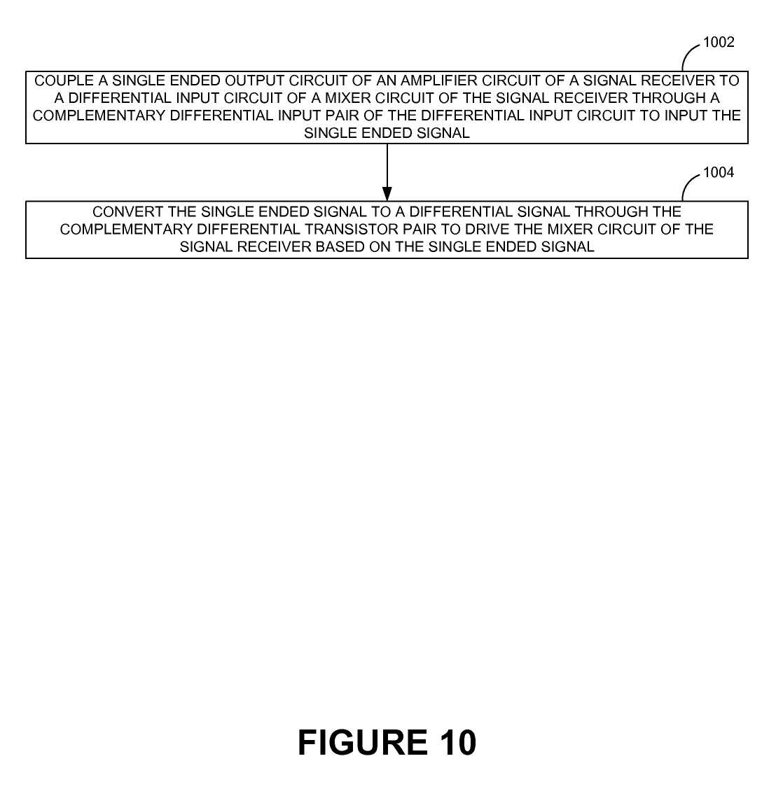

FIG. 10 is a process flow diagram illustrating the operation of the complementary differential transistor pair, according to one or more embodiments. In one or more embodiments, in operation 1002 the single ended output circuit 604 of an amplifier circuit 606 of the signal receiver 600 to a differential input circuit of a mixer circuit 100 of the signal receiver 600 through a complementary differential transistor pair 102 of the differential input circuit 104 of the mixer circuit 100 to input a single ended signal 110 from the single ended output circuit 606 of the amplifier circuit 606 to the mixer circuit 100. In operation 1004 a single ended signal 110 may be converted from the single ended output circuit 606 of the amplifier circuit 604 to a differential signal pair through the complementary differential transistor pair 102 of the differential input circuit 104 of the mixer circuit 100 to drive the mixer circuit based on the single ended signal.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware, firmware and software (e.g., embodied in a machine readable medium). For example, the various electrical structure and methods may be embodied using transistors, logic gates, and electrical circuits (e.g., application specific integrated (ASIC) circuitry and/or in digital signal processor (DSP) circuitry).

In addition, it will be appreciated that the various operations, processes, and methods disclosed herein may be embodied in a machine-readable medium and/or a machine accessible medium compatible with a data processing system (e.g., a computer devices), may be performed in any order (e.g., including using means for achieving the various operations). Accordingly, the specification and drawings are to be regarded in an illustrative rather than a restrictive sense.

What is claimed is:

1) A method comprising:
inputting a single ended signal to a mixer circuit comprising a differential input circuit through a complementary differential transistor pair of the differential input circuit of the mixer circuit; and
converting the signal ended signal to a differential signal through the complementary differential transistor pair of the differential input circuit to drive the mixer circuit.

2) The method of claim 1, further comprising:
generating a differential current in each of a branch of the mixer circuit associated with each of the transistors forming the complementary differential transistor pair through the complementary differential transistor pair of the differential input circuit of the mixer circuit;
converting the single ended signal to a differential signal pair compatible with the mixer circuit through generating the differential current via the complementary differential transistor pair, the differential current to form a differential signal pair; and
enabling the single ended signal to drive the mixer circuit through converting the single ended signal to a differential signal pair via the complementary differential transistor pair.

3) The method of the signal receiver of claim 1, wherein the complementary differential transistor pair of the differential input circuit of the mixer circuit to comprise an NMOS transistor coupled to a PMOS transistor.

4) The method of claim 1, further comprising:
increasing a voltage of the single ended signal applied to the complementary differential transistor pair of the differential input circuit to increase the current in the branch associated with the PMOS transistor while the current in the branch associated with the NMOS transistor is decreased simultaneously; and
decreasing the voltage of the single ended signal applied to the complementary differential transistor pair of the differential input circuit to decrease the current in the branch associated with the PMOS transistor while the current in the branch associated with the NMOS transistor is increased simultaneously.

5) The method of claim 1, further comprising substantially matching the current in the branch associated with the NMOS transistor of the complementary differential transistor pair to the current in the branch associated with the PMOS transistor of the complementary differential transistor pair to increase an efficiency of the mixer circuit.

6) The method of claim 1:
wherein the mixer circuit is a double balanced Gilbert cell architecture, and
wherein the differential input circuit of the mixer circuit comprising the complementary differential transistor pair is implemented in a standard CMOS technology.

7) A method of a signal receiver comprising:
coupling a single ended output circuit of an amplifier circuit of the signal receiver to a differential input circuit of a mixer circuit of the signal receiver through a complementary differential transistor pair of the differential input circuit of the mixer circuit to input a single ended signal from the single ended output circuit of the amplifier circuit to the mixer circuit; and
converting a single ended signal from the single ended output circuit of the amplifier circuit to a differential signal pair through the complementary differential transistor pair of the differential input circuit of the mixer circuit to drive the mixer circuit based on the single ended signal.

8) The method of the signal receiver of claim 7, further comprising:
generating a differential current in each of a branch of the mixer circuit associated with each of the transistors forming the complementary differential transistor pair through the complementary differential transistor pair of the differential input circuit of the mixer circuit; and
converting the single ended signal from the single ended output circuit of the amplifier circuit to a differential signal pair compatible with the mixer circuit through generating the differential current via the complementary differential transistor pair, the differential current to form a differential signal pair.
enabling the single ended signal of the single ended output circuit of the signal receiver to drive the mixer circuit of the signal receiver through converting the single ended signal to a differential signal pair via the complementary differential transistor pair, the differential current to form a differential signal pair.

9) The method of the signal receiver of claim 7, wherein the complementary differential transistor pair of the differential input circuit of the mixer circuit to comprise an NMOS transistor coupled to a PMOS transistor.

10) The method of the signal receiver of claim 7, wherein converting the single ended signal to a differential signal pair further comprising:
increasing a voltage of the single ended signal applied to the complementary differential transistor pair of the differential input circuit to increase the current in the branch associated with the PMOS transistor while the current in the branch associated with the NMOS transistor is decreased simultaneously; and
decreasing the voltage of the single ended signal applied to the complementary differential transistor pair of the differential input circuit to decrease the current in the branch associated with the PMOS transistor while the current in the branch associated with the NMOS transistor is increased simultaneously.

11) The method of the signal receiver of claim 7, further comprising substantially matching the current in the branch associated with the NMOS transistor of the complementary differential transistor pair to the current in the branch associated with the PMOS transistor of the complementary differential transistor pair to increase an efficiency of the mixer circuit.

12) The method of the signal receiver of claim 7:
wherein the signal receiver is an RF receiver,
wherein the amplifier circuit is a low noise amplifier,
wherein the mixer circuit is a double balanced Gilbert cell architecture, and
wherein the differential input circuit of the mixer circuit comprising the complementary differential transistor pair is implemented in a standard CMOS technology.

13) The method of the signal receiver of claim 7, further comprising reducing a circuit size of the signal receiver through enabling the single ended signal from the single ended output circuit of the amplifier circuit to drive the mixer circuit through converting the single ended signal to a differential signal pair via the complementary differential transistor pair.

14) A system comprising:
a receiver circuit to at receive a signal;
a mixer circuit of the receiver circuit to modify a frequency of the signal, the mixer circuit comprising:
a complementary differential transistor pair of a differential input circuit of the mixer circuit to convert the single ended signal inputted to the mixer circuit to a differential signal pair through the complementary differential transistor pair of the differential input circuit.

15) The system of claim 14:
wherein the complementary differential transistor pair of the differential input circuit of the mixer circuit to generate a differential current in each of a branch of the mixer circuit associated with each of the transistors forming the complementary differential transistor pair,
wherein the complementary differential transistor pair to convert the single ended signal to a differential signal pair compatible with the mixer circuit through generating the differential current via the complementary differential transistor pair, and
wherein the differential current to form a differential signal pair.

16) The system of claim 14:
wherein the single ended signal to drive the mixer circuit of the signal receiver through converting the single ended signal to a differential signal pair via the complementary differential transistor pair, and
wherein the complementary differential transistor pair of the differential input circuit of the mixer circuit to comprise an NMOS transistor coupled to a PMOS transistor.

17) The system of claim 14:
wherein increasing a voltage the single ended signal applied to the complementary differential transistor pair of the differential input circuit to increase the current in the branch associated with the PMOS transistor while the current in the branch associated with the NMOS transistor is decreased simultaneously, and
wherein decreasing the voltage of the single ended signal applied to the complementary differential transistor pair of the differential input circuit to decrease the current in the branch associated with the PMOS transistor while the current in the branch associated with the NMOS transistor is increased simultaneously.

18) The system of claim 14 wherein substantially matching the current in the branch associated with the NMOS transistor of the complementary differential transistor pair to the current in the branch associated with the PMOS transistor of the complementary differential transistor pair to increase an efficiency of the mixer circuit.

19) The system of claim 14:
wherein the receiver circuit is an RF receiver circuit,
wherein the mixer circuit is a double balanced Gilbert cell mixer, and
wherein the differential input circuit of the mixer circuit comprising the complementary differential transistor pair is implemented in a standard CMOS technology.

20) The method of claim 14, wherein enabling the single ended signal from the single ended output circuit of the amplifier circuit to drive the mixer circuit through converting the single ended signal to a differential signal pair via the complementary differential transistor pair to reduce a circuit size of the signal receiver.

21) A mixer circuit comprising:
a differential input circuit of the mixer circuit to input a single ended signal, the differential input circuit comprising:
a complementary differential transistor pair of a differential input circuit of the mixer circuit to convert the single ended signal to a differential signal pair to drive the mixer circuit.

22) The mixer circuit of claim 21 further comprising:
a cross coupled multiplier circuit of the mixer circuit coupled to the differential input circuit to multiply the differential signal pair from the differential input circuit with an oscillator signal from a local oscillator circuit that is separate from the mixer circuit through a switching operation of the cross coupled multiplier circuit; and
an output circuit to output the signal resulting from multiplying the oscillator signal with the differential signal pair.

23) The mixer circuit of claim 21:
wherein the complementary differential transistor pair of the differential input circuit of the mixer circuit to generate a differential current in each of a branch of the mixer circuit associated with each of the transistors forming the complementary differential transistor pair,
wherein the complementary differential transistor pair to convert the single ended signal to the differential signal pair compatible with the mixer circuit through generating the differential current via the complementary differential transistor pair, and
wherein the differential current to form a differential signal pair.

24) The mixer circuit of claim 21 wherein the complementary differential transistor pair of the differential input circuit of the mixer circuit to comprise an NMOS transistor coupled to a PMOS transistor.

25) The mixer circuit of claim 21:
wherein the single ended signal to drive the mixer circuit through converting the single ended signal to a differential signal pair via the complementary differential transistor pair,
wherein increasing a voltage of the single ended signal inputted to the complementary differential transistor pair of the differential input circuit to increase the current in the branch associated with the PMOS transistor while the current in the branch associated with the NMOS transistor is decreased simultaneously, and
wherein decreasing the voltage of the single ended signal applied to the complementary differential transistor pair of the differential input circuit to decrease the current in the branch associated with the PMOS transistor while the current in the branch associated with the NMOS transistor is increased simultaneously.

26) The mixer circuit of claim 21:
wherein substantially matching the current in the branch associated with the NMOS transistor of the complementary differential transistor pair to the current in the branch associated with the PMOS transistor of the complementary differential transistor pair to increase an efficiency of the mixer circuit,
wherein the mixer circuit is a double balanced Gilbert cell architecture, and
wherein the differential input circuit of the mixer circuit comprising the complementary differential transistor pair is implemented in a standard CMOS technology.
